(19) United States
(12) Patent Application Publication
(10) Pub. No.: US 2006/0268171 A1
(43) Pub. Date: Nov. 30, 2006

(54) Plasma display module

(76) Inventor: Myoung-Kon Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/440,297

(22) Filed: May 24, 2006

(30) Foreign Application Priority Data
May 25, 2005 (KR) 10-2005-0044261

(51) Int. Cl. H04N 11/08

(52) U.S. Cl. 348/490

(57) ABSTRACT

A plasma display module is disclosed. In one embodiment, the display module includes: i) a chassis base, ii) a plasma display panel on which an image is displayed, in front of the chassis base and supported by the chassis base, iii) a plurality of circuit substrates that drive the plasma display panel, on the rear of the chassis base and supported by the chassis base and iv) a pad attaching structure that brings a thermal conductive medium into close contact with at least a region of the circuit substrate and is located between the chassis base and the circuit substrate, and forms an air circulating path between the pad attaching structure and the chassis base. The plasma display module accelerates the dissipation of heat from the circuit devices and is cheap to manufacture.

### CROSS-REFERENCE TO RELATED PATENT APPLICATION

This application claims the benefit of Korean Patent Application No. 10-2005-0044261, filed on May 25, 2005, in the Korean Intellectual Property Office, the disclosure of which is incorporated herein in its entirety by reference.

### BACKGROUND OF THE INVENTION

1. Field of the Invention

The present invention relates to a plasma display module, and more particularly, to a plasma display module having a structure that accelerates heat dissipation from circuit devices that supply driving signals, and is cheaper to manufacture.

2. Description of the Related Technology

A plasma display module is a flat panel display device for displaying images by using a discharge effect. Due to its enhanced performances, such as high display capacity, high brightness, high contrast, lack of latent image, large viewing angle, etc., and the fact that it is thin with a large screen size, the PDP is expected to be a next generation display device which will replace the cathode ray tube (CRT).

FIG. 1 is a cross-sectional view of a conventional plasma display module. A typical plasma display module includes a plasma display panel 30 that includes a front panel 10 and a rear panel 20, a chassis base 50 that supports the plasma display panel 30 from behind, and a heat transfer sheet 40 interposed between the plasma display panel 30 and the chassis base 50. A plurality of circuit substrates 60 that include a plurality of circuit devices 61 for driving the plasma display panel 30 are also mounted on the rear of the chassis base 50. Driving power and signals generated by the circuit devices 61 are applied to the plasma display panel 30 through connection cables (not shown). A heat transfer medium 85 is interposed between the circuit substrates 60 and the chassis base 50, and is fixed to the rear of the chassis base 50 by screws 55 coupled to the chassis base 50 through the heat transfer medium 85 and the circuit substrates 60.

According to the heat radiation structure depicted in FIG. 1, since the heat transfer medium 85 transmits heat from the circuit substrates 60 to the chassis base 50 by making a direct connection therebetween, the volume of the heat transfer medium 85 is increased, which results in high manufacturing costs. The structure depicted in FIG. 1 also suffers from impaired heat dissipation from the circuit devices 61 by natural air convention, since no space for air circulation is provided between the circuit substrates 60 and the chassis base 50.

### SUMMARY OF CERTAIN INVENTIVE ASPECTS

One aspect of the present invention provides a plasma display module that accelerates the radiation of heat from circuit devices.

Another aspect of the present invention also provides a plasma display module that is cheap to manufacture.

Another aspect of the present invention provides a plasma display module comprising: i) a chassis base, ii) a plasma display panel on which an image is displayed and which is located in front of the chassis base and supported by the chassis base, iii) a plurality of circuit substrates that drive the plasma display panel, located on the rear of the chassis base and supported by the chassis base and iv) a pad attaching structure that brings a thermal conductive medium into close contact with at least a region of the circuit substrate, and is located between the chassis base and the circuit substrate and forms an air circulating path between the pad attaching structure and the chassis base.

The pad attaching structure may comprise a pressing plate parallel to the chassis base, a supporting unit bent toward the chassis base from the pressing plate, and a flange unit coupled to the chassis base and bent from the supporting unit.

An air circulating path for circulating air up and down may be formed between the pressing plate and the chassis base.

The pad attaching structure may comprise a pressing plate parallel to the chassis base, and coupling legs coupled to the circuit substrate and bent backward from the pressing plate. The coupling leg may have a stopper at its end part.

The stoppers of the coupling legs may be the stoppers of the coupling legs may be engaged with the edges of the coupling holes. Alternatively, the circuit substrate may comprise coupling holes, and the coupling legs may be fixed through the coupling holes.

The pad attaching structure may be a plate member in which through holes are formed and facing the circuit substrate, a plurality of coupling holes corresponding to the through holes are formed in the circuit substrates, and pad attaching structure and the circuit substrate are coupled by a coupling member, an end and the other end of which are respectively inserted into the through hole and the coupling hole.

The circuit substrate may be separated a predetermined distance from the chassis base by coupling to bosses which protrude backwards from the chassis base.

Another aspect of the invention provides a plasma display module, comprising a pad attaching structure located between a chassis base and a circuit substrate and configured to define an air circulation path between the pad attaching structure and the chassis base, wherein a thermal conductive medium is formed between a portion of the pad attaching structure and a portion of the circuit substrate.

Still another aspect of the invention provides a method of manufacturing, comprising i) providing a pad attaching structure, ii) placing the pad attaching structure between a chassis base and a circuit substrate so as to define an air circulation path between the pad attaching structure and the chassis base and iii) forming a thermal conductive medium between a portion of the pad attaching structure and a portion of the circuit substrate.

### BRIEF DESCRIPTION OF THE DRAWINGS

Embodiments of the present invention will be described with reference to the attached drawings.

FIG. 1 is a cross-sectional view of a conventional plasma display module.

FIG. 2 is an exploded perspective view of a plasma display module according to an embodiment of the present invention.

FIG. 3 is an enlarged exploded perspective view of a portion of the plasma display module of FIG. 2.

FIG. 4 is an exploded perspective view of a plasma display module according to another embodiment of the present invention.

FIG. 5 is a cross-sectional view taken along line V-V of FIG. 4.

FIG. 6 is a cross-sectional view of a modified version of the plasma display module of FIG. 5.

FIG. 7 is a cross-sectional view of a plasma display module according to still another embodiment of the present invention.

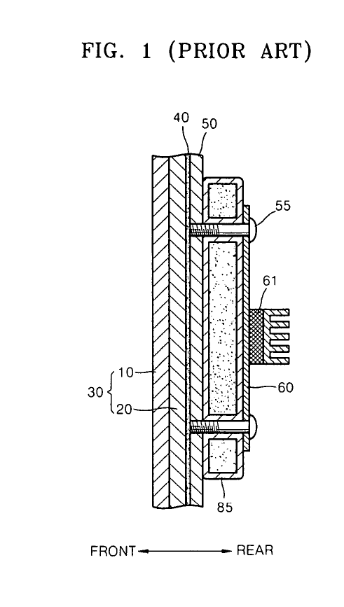

### DETAILED DESCRIPTION OF CERTAIN INVENTIVE EMBODIMENTS

Embodiments of the present invention will now be described more fully with reference to the accompanying drawings in which exemplary embodiments of the invention are shown.

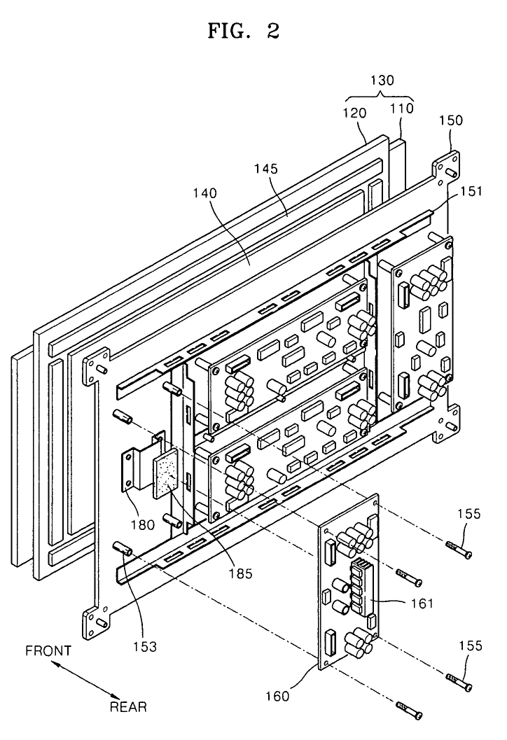

FIG. 2 is an exploded perspective view of a plasma display module according to an embodiment of the present invention. In one embodiment, the plasma display module includes a chassis base 150, a plasma display panel 130 for displaying images, which is supported by the chassis base 150 and located in front of the chassis base 150, and a plurality of circuit substrates 160 that supply driving power and signals to the plasma display panel 130 and are supported by the chassis base 150 and located on the rear of the chassis base 150. The plasma display panel 130 includes a front panel 110 and a rear panel 120 facing each other, and displays images using a discharge phenomenon. The plasma display panel 130 generates a large amount of heat due to the discharge. In one embodiment, a heat transfer sheet 140 is attached on most of the surface of the plasma display panel 130 to rapidly dissipate the heat. In one embodiment, double-sided adhesive tape 145 is attached to the heat transfer sheet 140 along its edges, to join the plasma display panel 130 to the chassis base 150.

The chassis base 150 mechanically supports other elements, and to reinforce the strength of the chassis base 150, a reinforcing member 151 can be installed on the rear of the chassis base 150 along vertical and horizontal directions of the chassis base 150. The circuit substrates 160, each performing a different function, are mounted on the rear of the chassis base 150, and a plurality of circuit devices 161 are mounted on the circuit substrates 160. In one embodiment, a plurality of bosses 153 protrude backward from the rear surface of the chassis base 150, and the circuit substrates 160 are fixed to the rear of the chassis base 150 by, for example, screws 155 which screw into the bosses 153 through the circuit substrates 160. The chassis base 150 functions as a heat dissipation plate for the plasma display panel 130 in front of the chassis base 150 and the circuit devices 161 to the rear of the chassis base 150. Therefore, the chassis base 150 may be formed of a metal having a high thermal conductivity, such as aluminum.

In one embodiment, as depicted in FIG. 2, a thermal conductive medium 185, and a pad attaching structure 180 are located between the chassis base 150 and the circuit substrates 160. The pad attaching structure 180 ensures close contact between the thermal conductive medium 185 and the circuit substrates 160. Here, the thermal conductive medium 185 can be located in a predetermined region of the circuit substrates 160 to accelerate the dissipation of heat generated from the circuit devices that produce relatively a large amount of heat, or can be located the entire surface of the circuit substrates 160.

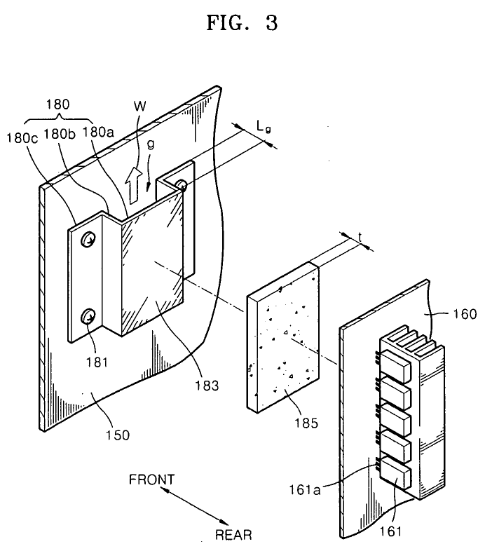

FIG. 3 is an enlargement of a pad attaching structure 180 of FIG. 2. In one embodiment, the pad attaching structure 180 includes a pressing plate 180a which is substantially parallel to the chassis base 150 and brings the thermal conductive medium 185 into close contact with the circuit substrates 160, supporting units 180b extending perpendicular from the pressing plate 180a toward the chassis base 150, and flange units 180c substantially parallel to the pressing plate 180 and coupled to the chassis base 150. In one embodiment, the flange unit 180c is fixed to the chassis base 150 by, for example, screws 181.

In one embodiment, the pressing plate 180a is separated a predetermined distance Lg backward from the chassis base 150 to form a vertical air circulation path g through which air can flow up and down. In this embodiment, the dissipation of heat from the circuit substrates 160 is accelerated by low temperature air w circulating through the air circulating path g. More specifically, the heat generated by the circuit devices 161 is transmitted to the pad attaching structure 180 through the thermal conductive medium 185, and the heat is dissipated on the pad attaching structure 180 by natural convention of external air w passing through the air circulating path g.

In one embodiment, the thermal conductive medium 185 is interposed between the pressing plate 180a and the circuit substrates 160. In one embodiment, the thermal conductive medium 185 accelerates heat dissipation from a predetermined region of the circuit substrates 160 by entirely contacting or, as depicted in FIG. 3, partly contacting the circuit substrates 160. The heat transmitted to the pressing plate 180a through the thermal conductive medium 185 is conducted to the chassis base 150 through the supporting unit 180b or, as described above, dissipated by natural convention.

In one embodiment, the thermal conductive medium 185 can be a pad impregnated with resin and a highly thermal conductive powder, such as aluminum powder or graphite powder, or can be a pocket with an external metal cover which accommodates a liquid-state heat transfer material, such as silicon, filling the pocket. The thermal conductive medium 185 may be designed to a thickness t of more than about 2 mm. This is because, in one embodiment, leads 161a of the circuit devices 161 protruded from the circuit substrate 160 toward the thermal conductive medium 185 is limited by up to about 2 mm. In one embodiment, the pad attaching structure 180 can be formed of a material having a high thermal conductivity, such as aluminum or SECC, or can be formed of a plastic such as a thermosetting plastic. The pad attaching structure 180 is not necessarily formed of a material having high thermal conductivity, since the heat dissipation of the circuit substrate 160 can be achieved by the thermal conductive medium 185.

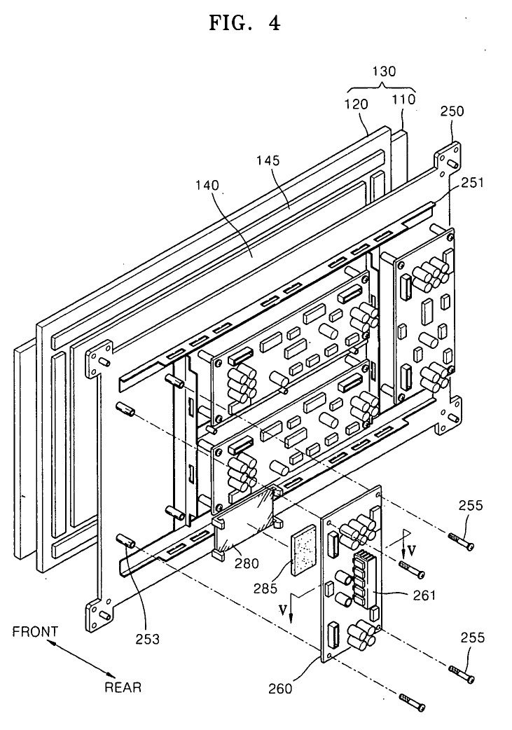

FIG. 4 is an exploded perspective view of a plasma display module according to another embodiment of the present invention. In one embodiment, the plasma display module also includes a plasma display panel 130 in front and a chassis base 250 in the rear. A plurality of circuit substrates 260 are mounted on the rear of the chassis base 250 by, for example, screws 255 which pass through the circuit substrates 260 and screw into bosses 253 which protrude from the rear of the chassis base 250. In one embodiment, a predetermined space is formed between the chassis base 250 and the circuit substrate 260 by the bosses 253.

In one embodiment, a thermal conductive medium 285 that takes in charge of transferring heat from a specific region of the circuit substrate 260, and a pad attaching structure 280 that ensures close contact between the thermal conductive medium 285 and the circuit substrate 260, are interposed between the chassis base 250 and the circuit substrate 260. In one embodiment, the pad attaching structure 280 brings the thermal conductive medium 285 into close contact with the circuit substrates 260 while the pad attaching structure 280 is attached to the circuit substrates 260. In one embodiment, the thermal conductive medium 285 can be mounted for dissipating heat from a portion of the circuit substrates 260, for example, a specific circuit device 261, or can be mounted for dissipating heat from all circuit devices 261 on the entire circuit substrate 260.

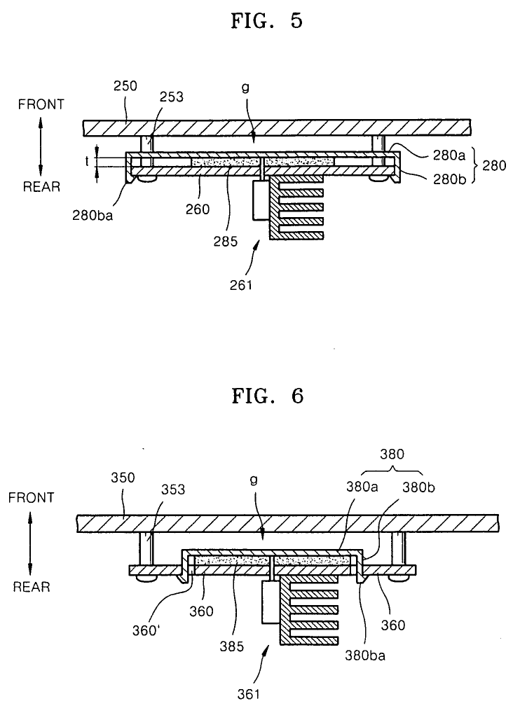

FIG. 5 is a cross-sectional view taken along line V-V of FIG. 4. In one embodiment, the pad attaching structure 280 includes a pressing plate 280a that presses the thermal conductive medium 285 onto circuit substrate 260, and a coupling leg 280b which bends backward from the pressing plate 280a and is coupled to the circuit substrate 260. In one embodiment, a stopper 280ba is formed at one end of the coupling leg 280b, and the pad attaching structure 280 is fixed to the circuit substrate 260 via the stopper 280ab which contacts the ends of the circuit substrate 260.

In one embodiment, the circuit substrate 260 is separated a predetermined distance from the chassis base 250 by the backwardly protruding bosses 253, and an air circulating path g through which air can flow up and down is formed between the chassis base 250 and the pressing plate 280a. In this embodiment, the dissipation of heat from the circuit substrates 260 is accelerated by circulating low temperature air through the air circulating path g.

FIG. 6 is a cross-sectional view of a modified version of the pad attaching structure of FIG. 5. In one embodiment, a pad attaching structure 380 includes a pressing plate 380a and coupling legs 380b which bend backward from the pressing plate 380a and is coupled to a circuit substrate 360. In one embodiment, a pair of coupling holes 360′ having a thermal conductive medium 385 therebetween is formed in the circuit substrate 360, and a stopper 380ba is formed at one end of a coupling leg 380b. In this embodiment, when the coupling leg 380b is inserted into the coupling hole 360′, the stopper 380ba engages with the edge of the coupling hole 360′ to fix the pad attaching structure 380 to the circuit substrate 360. In one embodiment, the circuit substrate 360 is spaced behind a predetermined distance from a chassis base 350 by bosses 353, and an air circulating path g is formed between the chassis base 350 and the pressing plate 380a. Air flowing through the air circulating path g accelerates the dissipation of heat from the circuit substrate 360. The pad attaching structure 380 can be mounted on a circuit device 361 that generates a large amount of heat, or can be mounted on the entire circuit substrate 360.

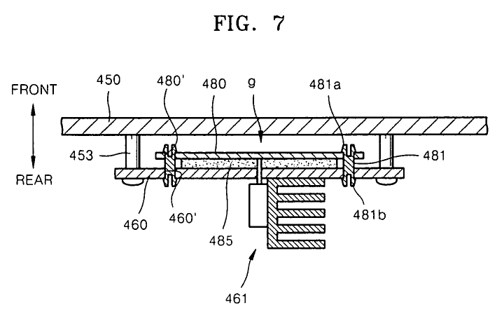

FIG. 7 is a cross-sectional view of a plasma display module according to still another embodiment of the present invention. Referring to FIG. 7, a circuit substrate 460 is mounted on the rear of a chassis base 450 by screws which pass through the circuit substrate 460 and screw into bosses which protrude backward from the chassis base 450.

In one embodiment, a thermal conductive medium 485 is attached to a region of the circuit substrate 460 using a pad attaching structure 480, and the pad attaching structure 480 is formed in a plate shape. In one embodiment, a pair of through holes 480′ having the thermal conductive medium 485 therebetween are formed through the pad attaching structure 480, and coupling holes 460′ corresponding to the through holes 480′ are formed through the circuit substrate 460. In one embodiment, the pad attaching structure 480 and the circuit substrate 460 are coupled to each other by coupling units 481 passing through the through holes 480′ of the pad attaching structure 480 and the coupling holes 460′ of the circuit substrate 460. In one embodiment, head units 481a and 481b of the coupling unit 481 are pressed inward allowing them to pass through the through hole 480′ and the coupling hole 360′, and then released to engage with the holes by moving back to their original positions. In one embodiment, the pad attaching structure 480 also forms an air circulating path g between the chassis base 450 by being separated a predetermined distance from the chassis base 450, and the heat generated by the circuit substrate 460 is dissipated by air flow through the air circulating path g.

Numeral 461 in FIG. 7 indicates a circuit device, and heat generated by the circuit device 461 is dissipated by the thermal conductive medium 485. The thermal conductive medium 485 may dissipate heat from the circuit device 461, or from all circuit devices mounted on the entire circuit substrate 460.

The plasma display module according to one embodiment of the present invention has the following advantages.

First, the heat dissipation from the circuit devices that supply driving power or signals is accelerated by including a pad attaching structure that brings a thermal conductive medium into close contact with the circuit substrate. Heat dissipation from the circuit devices is accelerated by natural air convention since a flow of low temperature air is induced by the pad attaching structure.

Second, the plasma display module is cheaper to manufacture. In the plasma display module, the volume of the thermal conductive medium is reduced by forming a predetermined space between the chassis base and the circuit substrate. This means that the thermal conductive medium can be manufactured at a lower cost, thereby reducing the overall manufacturing cost of the plasma display module.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A plasma display module, comprising:
a chassis base;
a plasma display panel configured to display an image, wherein the panel is located in front of the chassis base and supported by the chassis base;
a plurality of circuit substrates configured to drive the plasma display panel, wherein the plurality of circuit substrates are located on the rear of the chassis base and supported by the chassis base; and
a pad attaching structure that brings a thermal conductive medium into close contact with at least one of the circuit substrates, and is located between the chassis base and the at least one circuit substrate and forms an air circulating path between the pad attaching structure and the chassis base.

2. The plasma display module of claim 1, wherein the pad attaching structure comprises a pressing plate substantially parallel to the chassis base, a supporting unit bent toward the chassis base from the pressing plate, and a flange unit coupled to the chassis base and bent from the supporting unit.

3. The plasma display module of claim 2, wherein the thermal conductive medium is tightly fixed between the pressing plate and the at least one circuit substrate.

4. The plasma display module of claim 2, wherein an air circulating path configured to circulate air therethrough is formed between the pressing plate and the chassis base.

5. The plasma display module of claim 1, wherein the pad attaching structure comprises a pressing plate substantially parallel to the chassis base, and coupling legs bent backward from the pressing plate and coupled to the at least one circuit substrate.

6. The plasma display module of claim 5, wherein each coupling leg has a stopper at the end part thereof.

7. The plasma display module of claim 6, wherein the stoppers of the coupling legs are engaged with the edges of the at least one circuit substrate.

8. The plasma display module of claim 6, wherein coupling holes are formed in the at least one circuit substrate, and the coupling legs are fixed through the coupling holes.

9. The plasma display module of claim 1, wherein the pad attaching structure is a plate member in which at least one through hole is formed and facing the at least one circuit substrate, at least one coupling hole corresponding to the at least one through hole is formed in the at least one circuit substrate, and wherein the pad attaching structure and the circuit substrate are coupled by at least one coupling member, which is inserted into the at least one through hole coupling hole.

10. The plasma display module of claim 1, wherein the at least one circuit substrate is separated a predetermined distance from the chassis base by coupling to bosses which protrude backwards from the chassis base.

11. A plasma display module, comprising:
a pad attaching structure located between a chassis base and a circuit substrate and configured to define an air circulation path between the pad attaching structure and the chassis base, wherein a thermal conductive medium is formed between a portion of the pad attaching structure and a portion of the circuit substrate.

12. The plasma display module of claim 11, wherein the portion of the pad attaching structure is located adjacent to the air circulation path so that heated air is transferred to the air circulation path through the portion of the pad attaching structure.

13. The plasma display module of claim 11, wherein the pad attaching structure comprises i) side portions contacting the chassis base and ii) a plate portion extending from both ends of the side portions and arranged substantially parallel to the chassis base and the circuit substrate such that the air circulation path is defined between the side portions and the plate portion.

14. The plasma display module of claim 11, wherein the pad attaching structure comprises i) a plate portion arranged substantially parallel to the chassis base and the circuit substrate and ii) side portions protruding from both ends of the plate portion toward the circuit substrate, wherein neither of the plate portion and side portions contacts the chassis base such that the air circulation path is defined between the plate portion and the chassis base.

15. The plasma display module of claim 14, wherein each side portion has a stopper, at the end part thereof, configured to be engaged with both ends of the circuit substrate.

16. The plasma display module of claim 14, wherein a pair of coupling holes are defined in the circuit substrate, and wherein a part of the side portions pass through the coupling holes of the circuit substrate.

17. The plasma display module of claim 11, wherein the pad attaching structure comprises:
i) a plate portion arranged substantially parallel to the chassis base and the circuit substrate, wherein a first pair of through holes are defined in the plate portion and a second pair of through holes are defined in the circuit substrate; and
ii) a pair of coupling units configured to pass through the first and second pairs of through holes so as to couple the plate portion to the circuit substrate, wherein the air circulation path is defined between the plate portion and the chassis base.

18. A method of manufacturing a plasma display module, comprising:
providing a pad attaching structure;
placing the pad attaching structure between a chassis base and a circuit substrate so as to define an air circulation path between the pad attaching structure and the chassis base; and
forming a thermal conductive medium between a portion of the pad attaching structure and a portion of the circuit substrate.

19. The method of claim 18, further comprising coupling at least a portion of the pad attaching structure to the chassis base.

20. The method of claim 18, further comprising coupling at least a portion of the pad attaching structure to the circuit substrate, wherein the pad attaching structure does not contact the chassis base.
